(19) United States
(12) Patent Application Publication
(10) Pub. No.: US 2026/0318144 A1
(43) Pub. Date: Oct. 15, 2026

(54) METHOD FOR OPERATING A MOTOR-DRIVEN FLAP ASSEMBLY OF A MOTOR VEHICLE BY MEANS OF OPERATOR GESTURES

(71) Applicant: Brose Fahrzeugteile SE & Co. Kommanditgesellschaft, Bamberg, Bamberg (DE)

(72) Inventor: Bernd Herthan, Michelau (DE)

(21) Appl. No.: 19/106,519

(22) PCT Filed: Aug. 30, 2023
(86) PCT No.: PCT/EP2023/073527

§ 371 Date: Feb. 25, 2025

(30) Foreign Application Priority Data
Aug. 30, 2022 (DE) 10 2022 121 913.5

(51) Int. Cl. E05F 15/73

(52) U.S. Cl. CPC E05F 15/73; E05Y 2900/546

(57) ABSTRACT

A method for operating a motorized flap arrangement of a motor vehicle, using a sensor system having a plurality of radar modules, which are spaced apart from one another on the vehicle and have respective sensor controls, wherein the radar modules are used to determine respective radar sensor values with respect to an operator located outside the vehicle, wherein the sensor controls are used to check the radar sensor values determined by the respective radar module for the presence of a possible operator gesture on the basis of predetermined operator gesture criteria, wherein, within the scope of the check, the sensor controls are used to assign a detection quality measure to the possible operator gesture on the basis of the radar sensor values determined by the respective radar module, wherein the respective detection quality measures determined by the sensor controls are transmitted to a control unit of the sensor system.

### CROSS-REFERENCE TO RELATED APPLICATIONS

This application is a national stage application under 35 U.S.C. 371 of International Patent Application Serial No. PCT/EP2023/073527, entitled “Method for Operating a Motor-Driven Flap Assembly of a Motor Vehicle by Means of Operator Gestures,” filed Aug. 30, 2023, which claims priority from German Patent Application No. DE 10 2022 121 913.5, filed Aug. 30, 2022, the disclosure of which is incorporated herein by reference.

### FIELD OF THE TECHNOLOGY

Various embodiments provide a method for operating a motorized flap arrangement of a motor vehicle, to a control unit for a sensor system for operating a motorized flap arrangement of a motor vehicle, to a sensor system having such a control unit, and to a motor vehicle for carrying out the proposed method.

### BACKGROUND

The known prior art (DE 10 2016 125 371 A1), on which some embodiments are based, relates to a method for operating a motorized flap arrangement, wherein the motorized adjustment is triggered via a predetermined operator gesture. For example, the operator gesture is a predefined foot movement of the operator. For this purpose, movements performed by an operator are detected by a radar module and evaluated by means of a control unit.

### SUMMARY

The sensor systems used for such applications can have radar modules based on the use of ultra-wideband (UWB) technology. In addition to the radar operation, UWB radar modules are also designed for UWB communication with an operator's mobile device, such as an electronic key, for authentication. In many cases, however, this dual function is also associated with a limited resolution of the detection of the operator gesture. In principle, it is possible to provide a plurality of radar modules which are distributed around the circumference of the motor vehicle, and therefore, inter alia, the receiving and transmission range of the sensor system is optimized.

The radar modules are equipped with respective sensor controls which take over the evaluation of the radar sensor values determined by the respective radar module and which detect a valid operator gesture, for example, on the basis of the check of predetermined operator gesture criteria. If a valid operator gesture is present, the respective sensor control reports the presence of an actuating request to the control unit, which in turn activates the motorized flap arrangement, for example, opening of the tailgate.

It is a challenge here to improve the reliability of the detection of valid operator gestures, but at the same time the intention is to reduce the probability of an erroneous activation by a movement incorrectly qualified as valid operator gesture.

Various embodiments are based on the problem of configuring and developing the known method in such a way that further optimization as regards the aforementioned challenge is achieved.

The above problem is solved by various features described herein.

The motorized flap arrangement in question is provided for adjusting a closure element of the motor vehicle by means of an electric drive. The term “closure element” should be broadly understood in this context and comprises, for example, a tailgate, a rear cover, a bonnet, a side door, a cargo compartment flap, a window pane, a lifting roof or the like of a motor vehicle. The closure element can be arranged pivotably and/or longitudinally displaceably on the motor vehicle body. In the following, the focus is on the application area of adjusting tailgates and side doors.

Various embodiments are based on the finding that valid operator gestures are also performed in certain cases in such a way that the detection by the respective individual radar modules may be made difficult due to a low degree of triggering. An example of this is the performing of an operator gesture between two spaced-apart radar modules with only little covering of the respective detection ranges.

The fundamental consideration is to achieve a more reliable detection of the operator gesture by means of a specific combination of the results provided by the individual radar modules, with all of the radar modules being taken into account.

It is provided that the sensor controls of the radar modules each carry out a check of predetermined operator gesture criteria on the basis of the radar sensor values determined by the respective radar module. The radar modules therefore each make an assessment as to whether a possible operator gesture is present. In this case, a detection quality measure which is generally connected to the probability that a valid operator gesture has been detected is in each case assigned by the sensor controls to the possible operator gesture.

The control unit is superior to the sensor controls and in some embodiments does not carry out an immediate evaluation of the respective radar sensor data. On the contrary, the respective detection quality measures are transmitted to the control unit and evaluated in a summary according to an evaluation specification.

Accordingly, even, for example, a low detection quality for a gesture, which is nevertheless determined by a plurality of radar modules, can lead to successful triggering of the motorized adjustment, for example when the operator gesture is performed between two spaced-apart radar modules. However, since the requirements in the operator gesture criteria to be checked by the individual sensor controls do not necessarily have to be reduced, the probability of an erroneous triggering can still be reduced.

In various embodiments, according to which respective operator gesture parameters derived from the radar sensor values are assigned to the possible operator gesture by the sensor controls and taken into consideration in the evaluation specification, are also possible. Further characteristics of the detected possible operator gesture can therefore be incorporated in the evaluation by a summary.

Various embodiments specify in this connection a temporal aspect of the possible operator gesture, such as a duration, as an operator gesture parameter, as a result of which a valid operator gesture can be particularly reliably checked for plausibility by a plurality of radar modules.

In various embodiments, a speed value, which can be derived, for example, from Doppler information of the radar sensor values, is specified as an operator gesture parameter. The speed value serves in turn as a characteristic feature of the operator gesture and in particular improves the reliability against erroneous triggering.

In addition, in various embodiments, refinements of the operator gesture parameter are specified, which relate to the position of the operator gesture and in particular to radar targets associated with the operator gesture. Also by this means, the advantages of using radar for gesture detection can be used in a targeted manner in the summary.

Various embodiments relate to the use of the radar modules for UWB communication with a mobile device, for example an electronic key, which can be furthermore used here in addition to an authentication for improving the gesture detection.

In various embodiments, according to which the radar modules are also used for detecting an operator proximity. For example, for this purpose, operator proximity criteria, which represent the probability of the presence of a targeted approach of the operator to the flap arrangement with an actuation request, are predetermined. By combining the detection quality measures with the detected operator proximity, the gesture detection can be further optimized. For example, a low detection quality measure determined by one or more radar modules may be sufficient for triggering if another radar module has detected such an operator proximity with a high degree of probability.

Refinements with regard to the evaluation specification and the preparation thereof are specified in various embodiments.

The proposed method manages with a comparatively small amount of data, which has to be exchanged between the sensor controls and the control unit. Accordingly, a communication network of the motor vehicle, a LIN bus or CAN bus in the refinements according to various embodiments, is loaded only to a small extent.

According to various embodiments, a control unit for a sensor system for operating a motorized flap arrangement of a motor vehicle is provided. The control unit is designed to obtain, from a plurality of radar modules of the sensor system, respective detection quality measures for a possible operator gesture detected by means of the radar modules on the basis of radar sensor values, wherein the control unit qualifies the possible operator gesture as a valid operator gesture or rejects it as an invalid operator gesture according to a predetermined evaluation specification on the basis of a summary of the detection quality measures, and wherein the control unit initiates activation of the motorized flap arrangement when a valid operator gesture is present. Reference may be made to all the embodiments of the proposed method.

According to various embodiments, a control arrangement for a motorized flap arrangement of a motor vehicle is provided. The sensor system has a plurality of radar modules, which are spaced apart from one another on the motor vehicle and have respective sensor controls, wherein the radar modules, by sending and receiving radar signals, determine respective radar sensor values with respect to an operator located outside the motor vehicle, wherein the sensor controls check the radar sensor values determined by the respective radar module for the presence of a possible operator gesture on the basis of predetermined operator gesture criteria, and wherein, within the scope of the check, the sensor controls assign a detection quality measure to the possible operator gesture on the basis of the radar sensor values determined by the respective radar module.

The sensor system also has a proposed control unit. Reference may be made to all the embodiments of the proposed method and the proposed control unit.

According to various embodiments, a motor vehicle for carrying out the proposed method is provided. Reference may be made to all the embodiments of the proposed method, control unit and the proposed sensor system.

Various embodiments provide a method for operating a motorized flap arrangement of a motor vehicle, using a sensor system having a plurality of radar modules, which are spaced apart from one another on the motor vehicle and have respective sensor controls, wherein the radar modules, by sending and receiving radar signals, are used to determine respective radar sensor values with respect to an operator located outside the motor vehicle, wherein the sensor controls are used to check the radar sensor values determined by the respective radar module for the presence of a possible operator gesture on the basis of predetermined operator gesture criteria, wherein, within the scope of the check, the sensor controls are used to assign a detection quality measure to the possible operator gesture on the basis of the radar sensor values determined by the respective radar module, wherein the respective detection quality measures determined by means of the sensor controls are transmitted to a control unit of the sensor system, wherein the control unit is used to qualify the possible operator gesture as a valid operator gesture or to reject it as an invalid operator gesture, in accordance with a predetermined evaluation specification on the basis of a summary of the detection quality measures, and wherein the control unit is used to initiate activation of the motorized flap arrangement when a valid operator gesture is present.

In various embodiments, the sensor controls are used to derive at least one operator gesture parameter from the radar sensor values, determined by the respective radar module, of the possible operator gesture and to assign the operator gesture parameter to the possible operator gesture, in that the detection quality measures are transmitted together with the assigned operator gesture parameters to the control unit, and in that the evaluation specification is dependent on the assigned operator gesture parameters.

In various embodiments, at least one operator gesture parameter relates to a temporal aspect of the possible operator gesture, such as a duration, a start time and/or an end time of the possible operator gesture.

In various embodiments, at least one operator gesture parameter relates to a speed value, in particular a maximum speed, average speed and/or an acceleration value, of the possible operator gesture.

In various embodiments, at least one operator gesture parameter relates to a geometric aspect of the possible operator gesture, in particular a position of the possible operator gesture relative to the motor vehicle. In some embodiments, the respective sensor control is used on the basis of the radar sensor values to associate radar targets with the possible operator gesture, and in that at least one operator gesture parameter relates to the position, the number, the spatial distribution and/or a radar signal strength of the radar targets.

In various embodiments, at least one of the radar modules is used for UWB communication with a mobile device of the operator, in that the sensor control of the at least one radar module is used to determine time information and/or position information with respect to the mobile device and to transmit same to the control unit, and in that the evaluation specification is dependent on the time information and/or position information. In some embodiments, with establishment of the UWB communication, at least a further of the radar modules is activated.

In various embodiments, the sensor controls are used to check the radar sensor values, which are determined by the respective radar module, on the basis of predetermined operator proximity criteria for the presence of a possible operator proximity to the flap arrangement and the presence of the possible operator proximity is transmitted to the control unit, and in that the evaluation specification is dependent on the presence of the possible operator proximity.

In various embodiments, the evaluation specification is based on a trained machine learning model.

In various embodiments, the evaluation specification is based on fuzzy logic.

In various embodiments, the sensor controls communicate with the control unit, in particular for transmitting the detection quality measures, via a LIN bus or a CAN bus of the motor vehicle.

Various embodiments provide a control unit for a sensor system for operating a motorized flap arrangement of a motor vehicle, wherein the control unit is designed to obtain, from a plurality of radar modules of the sensor system, respective detection quality measures for a possible operator gesture detected by means of the radar modules on the basis of radar sensor values, wherein the control unit qualifies the possible operator gesture as a valid operator gesture or rejects it as an invalid operator gesture according to a predetermined evaluation specification on the basis of a summary of the detection quality measures, and wherein the control unit initiates activation of the motorized flap arrangement when a valid operator gesture is present.

Various embodiments provide a sensor arrangement for a motorized flap arrangement of a motor vehicle, the sensor system comprising a plurality of radar modules, which are spaced apart from one another on the motor vehicle and have respective sensor controls, wherein the radar modules, by sending and receiving radar signals, determine respective radar sensor values with respect to an operator located outside the motor vehicle, wherein the sensor controls check the radar sensor values determined by the respective radar module for the presence of a possible operator gesture on the basis of predetermined operator gesture criteria, and wherein, within the scope of the check, the sensor controls assign a detection quality measure to the possible operator gesture on the basis of the radar sensor values determined by the respective radar module, the sensor system comprising a control unit as described herein.

Various embodiments provide a motor vehicle for carrying out the method as described herein.

### BRIEF DESCRIPTION OF THE DRAWINGS

Various aspects are explained in more detail below with reference to a drawing that merely illustrates exemplary embodiments. In the drawing:

FIG. 1 shows a perspective view of a rear region of a motor vehicle for carrying out the proposed method with a proposed sensor arrangement,

FIG. 2 shows a) to d) various examples of a possible operator gesture in a top view of the rear region of the motor vehicle from FIG. 1, and

FIG. 3 shows a flow diagram of the proposed method.

### DETAILED DESCRIPTION

The proposed method relates to the operation of a motorized flap arrangement 1 of a motor vehicle 2. In various embodiments, such as illustrated, the flap arrangement 1 is provided for transferring the closure element of the flap arrangement 1 from a closed position into an open position. Transfer from an open position into a closed position can also be provided. In various embodiments, drives 3, which are configured as spindle drives, of a drive arrangement 4 and are arranged on opposite sides of the closure element are provided.

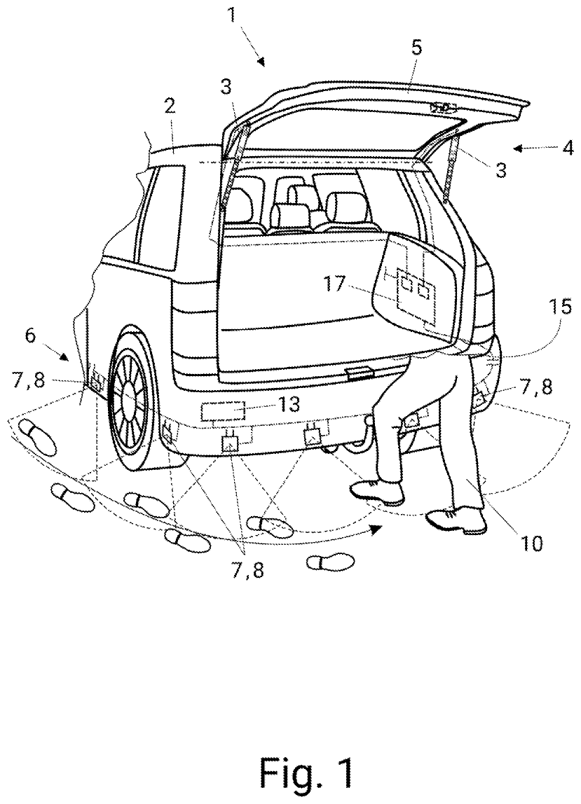

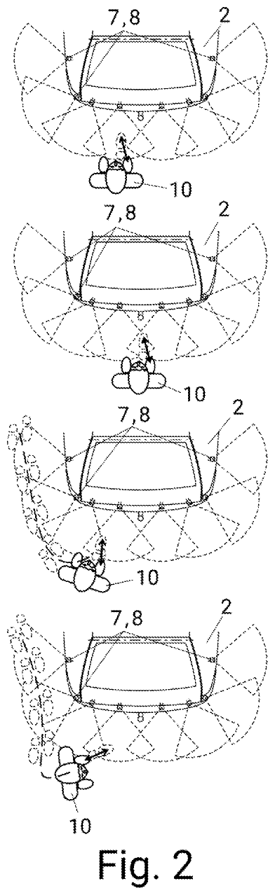

In principle, other motorized adjustment functions of the flap arrangement 1 may also be provided, for example, an unlocking and/or opening of a motor vehicle lock associated with the closure element. For possible refinements of the closure element, reference is made to the introductory statements, wherein in FIGS. 1 and 2 the closure element is illustrated by way of example as a tailgate 5.

A sensor system 6 having a plurality of radar modules 7 is provided, which sensor system is used in the context of gesture detection for triggering the motorized adjustment of the flap arrangement 1. The radar modules 7 are spaced apart on the motor vehicle 2, and therefore the sensor system 6 can use a plurality of spatially distributed radar modules 7 during operation. Owing to the spaced arrangement, an extended detection and transmission range of the sensor system 6 can be covered. In addition, the spaced arrangement of the radar modules 7 can be used for improved positioning, for example in the context of a triangulation or taking into account a redundancy of the radar modules 7.

The radar modules 7 can be designed as UWB modules for operation with UWB technology and in particular for communication in the frequency range of 3.1 GHz to 10.6 GHz. The UWB signals can be pulses with a bandwidth of at least 500 MHz, furthermore with a duration of the order of nanoseconds. The radar modules 7 have respective sensor controls 8, wherein the radar modules 7 can be designed as integrated modules with an antenna arrangement and the sensor control 8 designed, for example, as a microcontroller, in a unit.

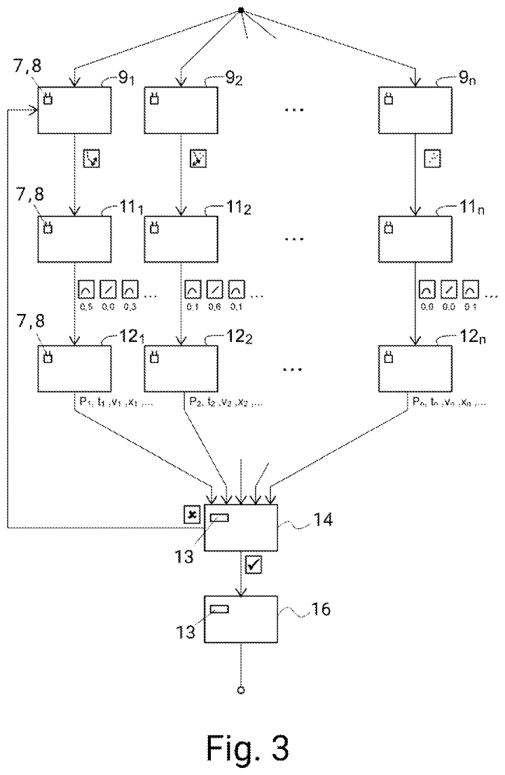

FIG. 3 shows an exemplary flow diagram of the proposed method. In action 9, the radar modules 7, by sending and receiving radar signals, are used to determine respective radar sensor values with respect to an operator 10 located outside the motor vehicle 2. Action 9 here comprises a plurality of sub-actions 9₁, 9₂, . . . , 9ₙ which are carried out by the respective radar modules 7 and can be undertaken simultaneously and/or with a time delay.

The radar sensor values here are indicative of distance information of at least one body part of the operator 10 from the respective radar module 7. In particular, the radar sensor values are also indicative of direction information and furthermore, in some embodiments, of speed information of the operator 10. In various embodiments, the radar modules 7 are each equipped with an antenna arrangement, which has one antenna, in some embodiments precisely two antennas, arranged in a predetermined angular setting and position to each other in order to allow an angular resolution of the radar signals. The sensor control 8 activates the respective antenna arrangement to send the radar signals. Receiving radar signals are evaluated by the sensor control 8 and, on the basis thereof, the radar sensor values are determined by means of the sensor control 8.

In action 11, here with the sub-actions 11₁, 11₂, . . . , 11ₙ, the sensor controls 8 are used to check the radar sensor values determined by the respective radar module 7 for the presence of a possible operator gesture on the basis of predetermined operator gesture criteria. The operator gesture criteria can relate here to predetermined characteristics of the operator gesture to be performed, for example, the position, speed, acceleration of a body part or the like. The detected radar sensor values can be checked for conformity with the specified characteristics and respective degrees of similarity which are indicative of the extent to which the radar sensor values are representative of an operator gesture with the respective characteristic can be determined. The degrees of similarity of the individual characteristics could be combined to form an overall degree of similarity, for example via predetermined functional relationships, such as coefficients or the like.

In action 12, here with sub-actions 12₁, 12₂, . . . , 12ₙ, the sensor controls 8 are used within the context of the check of the operator gesture criteria to assign a detection quality measure to the possible operator gesture on the basis of the radar sensor values determined by the respective radar module 7. The detection quality measure is generally representative of the probability p₁, p₂, . . . , pₙ with which a valid operator gesture was detected by the individual radar module 7. In a simple refinement, the detection quality measure can relate to the overall degree of similarity already discussed. The detection quality measure may also be given by a plurality of values and, for example, by the degrees of similarity of a plurality of the checked characteristics.

With the examination of the operator gesture criteria and the assignment of the detection quality measure by the respective sensor control 8, the immediate evaluation of the radar sensor values is implemented by the respective radar modules 7 themselves.

For further evaluation and combining of the gesture detection carried out by the radar modules 7, a control unit 13 of the sensor system 6 is provided, which in some embodiments, is superior to the sensor controls 8. In action 14, the respective detection quality measures determined by means of the sensor controls 8 are transmitted to the control unit 13 of the sensor system 6, wherein here and in some embodiments a communication network 15 of the motor vehicle 2 that is yet to be explained is used for the transmission.

In action 16, the possible operator gesture is qualified as a valid operator gesture or rejected as an invalid operator gesture by means of the control unit 13 according to a predetermined evaluation specification on the basis of a summary of the detection quality measures. The evaluation specification is a (calculation) specification in that it can be assessed from the individual detection quality measures and in some embodiments further information transmitted by the sensor controls 8 of the radar modules 7 whether a valid operator gesture is present or not. A “summary” of the detection quality measures means that a plurality of the transmitted detection quality measures of individual radar sensor modules are used and placed into relation to one another in order to check if a valid operator gesture is present.

It is not excluded here that, in individual cases, even a single, in some embodiments sufficiently high, detection quality measure is sufficient for a qualification as a valid operator gesture. An example of this is shown in FIG. 2a), in which the operator 10 performs an operator gesture in an optimum region for detection by one of the radar modules 7 and/or in an optimum orientation. In this case, the detection quality measure, which is assigned to the possible operator gesture by the sensor control 8 of the relevant radar module 7, may already be sufficiently high. In such a case, a single radar module 7 may therefore already be sufficient for reliable gesture detection.

In FIG. 2b), on the other hand, a situation is shown by way of example in which the operator 10 performs the operator gesture between two radar modules 7 and thus in an edge region of the detection range of the radar modules 7. This may result in that, although the operator gesture is detected by both radar modules 7, the relevant radar sensor values are present only with a comparatively low resolution. Also, for example, in the case of an operator gesture defined as a backward and forward movement of a radar module 7, predominantly a forward movement can be detected, while the backward movement is predominantly detected by another radar module 7. Accordingly, the operator gesture can then only be partially recorded in the radar sensor values by individual radar modules 7. Here, in the situation shown in FIG. 2b), a comparatively low detection quality measure for each of the two radar modules 7 results, which is transmitted to the control unit 13.

However, by combining the detection quality measures, the operator gesture performed can be correctly qualified as a valid operator gesture. In the evaluation specification, circumstances such as a gesture detection carried out just by adjacent radar modules 7 can accordingly be taken into account.

In action 16, the control unit 13 is used to initiate activation of the motorized flap arrangement 1 when a valid operator gesture is present. In various embodiments, the sensor arrangement transmits detection information to a door control device 17 external to the sensor arrangement. The door control device 17 can, for example, undertake an activation for the motorized adjustment depending on further conditions, such as a closed state of the motor vehicle 2 or the detection of an electronic key. In a departure from FIG. 1, the control unit 13 can also be integrated in a door control device 17 and, for example, undertake the activation of the motorized flap arrangement 1 itself.

It is furthermore provided in various embodiments that the sensor controls 8 are used to derive at least one operator gesture parameter from the radar sensor values, determined by the respective radar module 7, of the possible operator gesture and to assign the operator gesture parameter to the possible operator gesture, that the detection quality measures are transmitted together with the assigned operator gesture parameters to the control unit 13, and that the evaluation specification is dependent on the assigned operator gesture parameters.

The operator gesture parameter is derived from the radar sensor values and thus results from the sensor-based detection of the operator 10 by means of the radar signals. The operator gesture parameter relates to a variable which can be determined by sensors, is related to the possible operator gesture and is suitable for further characterizing of the possible operator gesture. The at least one operator gesture parameter is determined here, in addition to the already discussed detection quality measure, in each case by the sensor controls 8 and in turn transmitted to the control unit 13. The fact that the evaluation specification is dependent on the assigned operator gesture parameters means in this case that the result of the qualification as a valid or invalid operator gesture can be influenced by different values of the operator gesture parameters.

In various embodiments, it is provided that at least one operator gesture parameter relates to a temporal aspect t₁, t₂, . . . , tₙ of the possible operator gesture, such as a duration, a start time and/or an end time of the possible operator gesture.

A comparison of the temporal aspects t₁, t₂, . . . , tₙ, for example the duration, detected by the respective radar modules 7 can be correspondingly depicted in the evaluation specification. For example, if the durations within a predetermined accuracy correspond to one another, a valid operator gesture may be more likely. By comparing temporal aspects, erroneous triggering due to other movements detected by the radar modules 7 can also be avoided.

To determine the temporal aspect, such as the duration, the start time and/or the end time, predetermined criteria can be used by means of the sensor control 8. For example, the start time and end time are defined on the basis of speed values of the operator gesture, such as via threshold values or the like. The duration here can result from the time difference of such defined start and end times.

It is furthermore provided in various embodiments that at least one operator gesture parameter relates to a speed value v₁, v₂, . . . , vₙ, in particular a maximum speed, average speed and/or an acceleration value, of the possible operator gesture.

A comparison of the speed values v₁, v₂, . . . , vₙ detected by the respective radar modules 7 can also be depicted here in the evaluation specification. The speed values v₁, v₂, . . . , vₙ can be determined from Doppler information of the radar signals. An example of an evaluation specification which is dependent on the speed values v₁, v₂, . . . , vₙ is that, for a possible operator gesture with higher speed values v₁, v₂, . . . , vₙ, lower requirements are placed on the summary of the detection quality measures than for a possible operator gesture with low speed values v₁, v₂, . . . , vₙ.

It is further provided in various embodiments that at least one operator gesture parameter relates to a geometric aspect x₁, x₂, . . . , xₙ of the possible operator gesture, in particular a position of the possible operator gesture relative to the motor vehicle 2.

The position may be present here as distance information and/or angle information between the possible operator gesture and the respective radar module 7. The consideration of the position is advantageous in particular when detecting a possible operator gesture by two or more adjacent radar modules 7, as is also shown in FIG. 2b). In particular, a comparison of the positions can allow a conclusion here as to whether the low detection quality measures are due to the same movement detected by different radar modules 7.

By means of the respective sensor control 8, an association of radar targets with the possible operator gesture can be undertaken on the basis of the radar sensor values, wherein at least one operator gesture parameter relates to the position, the number, the spatial distribution and/or a radar signal strength of the radar targets.

In various embodiments, a time-dependent association of the radar sensor values with the operator 10 is undertaken by means of the sensor controls 8 in each case in a target tracking routine. The radar targets are identified in the radar sensor values, in particular on the basis of the intensity of the reflected radar signals and, in some embodiments, on the basis of exceeding a predetermined intensity threshold value. Individual radar targets from among these radar targets are associated in the target tracking routine with the operator 10, wherein, in particular in a temporal sequence of radar sensor values, the course of movement of these radar targets is determined. The course of movement of the radar targets can be used to check the operator gesture criteria.

The at least one operator gesture parameter can contain additional information regarding such radar targets. The position can in turn mean distance information and/or angle information from the respective radar module 7 to the radar target. In particular, a plurality of radar targets detected in the sensor values according to a cluster model are combined to form a cluster target and associated with the body part, wherein the operator gesture parameter can indicate the number of combined radar targets. The spatial distribution can mean the surface area spanned by the radar targets, the volume spanned and/or the shape defined by the radar targets. The radar signal strength is determined in particular by the intensity of the reflected radar signals.

It is furthermore provided in some embodiments that at least one of the radar modules 7 is used to undertake UWB communication with a mobile device 18 of the operator 10. The mobile device 18 can be designed, for example, as an electronic key, mobile phone, PDA, wearable or the like. The mobile device 18 is designed for UWB communication with at least one of the radar modules 7, wherein, in addition to an authentication of the operator 10, positioning can also be undertaken by means of the UWB communication.

In various embodiments, the sensor control 8 of the at least one radar module 7, which carries out the UWB communication, is used to determine time information and/or position information with respect to the mobile device 18 and to transmit same to the control unit 13. The evaluation specification can be dependent here on the time information and/or position information.

The time information is provided, for example, by the time at which the UWB communication was established, for example, by the (first) time of a successful authentication. The time difference between the authentication and a temporal aspect of the possible operator gesture can be a criterion here for distinguishing between a valid and an invalid operator gesture. The position information can be understood in turn as distance information and/or angle information between the radar module 7 and the mobile device 18, which can also be used in addition to the detection quality measures and in particular the operator gesture parameters.

It is provided, in various embodiments, that at least one further radar module from among the radar modules 7 is activated when the UWB communication is established. Such an awakening of the further radar modules 7 can be undertaken in particular by means of the control unit 13.

Furthermore, it is provided, in various embodiments, that the sensor controls 8 are used to check the radar sensor values, which are determined by the respective radar module 7, on the basis of predetermined operator proximity criteria for the presence of a possible operator proximity to the flap arrangement 1 and the presence of the possible operator proximity is transmitted to the control unit 13, and that the evaluation specification is dependent on the presence of the possible operator proximity.

The operator proximity criteria can generally represent here the performing of operator actions before the operator gesture and in particular a movement pattern directed to the flap arrangement 1 and run through by the operator 10. By way of example, an operator action beforehand is shown in FIG. 2c), in which the operator 10 approaches the tailgate 5 in an approach movement around the motor vehicle 2 and then performs an operator gesture. In this example, the possible operator gesture is assigned only a low detection quality measure by at least one of the radar modules 7, for example because the operator gesture is detected with low resolution at the edge of the detection range.

However, the operator action beforehand can be detected via further radar modules 7 and classified as a probable operator approach with actuating intent on the basis of the operator proximity criteria. For example, the requirements placed on a qualification as a valid operator gesture are then reduced to the detection quality measures.

The detecting of operator actions beforehand can also be used to avoid erroneous triggering. If the operator 10, for example, performs an operator action, which, as shown in FIG. 2d), corresponds more to moving past the motor vehicle 2, the check of the operator proximity criteria can result in a low probability of an actuation intent. Accordingly, the requirements placed on a qualification as a valid operator gesture are increased to the detection quality measure so that operator actions, such as a running movement of the operator 10, are not incorrectly qualified as a valid operator gesture.

The detected operator proximity—like the possible operator gesture—can be assigned a detection quality measure and in particular operator proximity parameters, analogously to the explained operator gesture parameters, and transmitted to the control unit 13, wherein the evaluation specification is furthermore dependent on the detection quality measure and in particular the operator proximity parameters. The above statements regarding the summary of operator gesture characteristics also apply correspondingly to the operator proximity.

The evaluation specification can be designed and generated in different ways. In various embodiments, it is provided that the evaluation specification is based on a trained machine learning model.

The trained machine learning model can be trained in a training routine. A training data set can be created here, with a readjustment of various operator actions—including valid and invalid operator gestures—on a sensor system 6, which is annotated accordingly. In the training routine, a predefined machine learning model is trained using the training data set and the trained machine learning model is stored in the control unit 13.

In various embodiments, the training data set is generated with a plurality of operator gesture parameters, with it being possible, in the training routine, to use a plurality of different sets of operator gesture parameters. The reliability of gesture detection in the training routine can be used to determine which set of operator gesture parameters is optimum for the given sensor system 6.

Furthermore, it can be provided in various embodiments that the evaluation specification is based on fuzzy logic. The fuzzy logic is particularly suitable here for linking detection quality measures present as “fuzzy sets” to one another. In particular, rules can be established via the fuzzy logic as to the way in which individual probabilities can be combined from the detection quality measures to form an overall probability. The fuzzy logic can be created at least partly empirically.

The sensor controls 8 and the control unit 13 communicate via an, in particular wired, communication network 15 of the motor vehicle 2. In various embodiments, it is provided that the sensor controls 8 communicate with the control unit 13, in particular for transmitting the detection quality measures, via a LIN bus or a CAN bus of the motor vehicle 2.

In particular, the proposed method requires only a small amount of data to be transmitted via the communication network 15 such that a LIN bus or CAN bus is thereby only slightly loaded. In particular, the transmission of raw data, such as sets of radar sensor values, to the control unit 13 can be dispensed with.

In various embodiments, the data transmitted via the communication network 15 for the purpose of gesture detection are limited to the detection measures, the operator gesture parameters and optionally to information regarding the possible operator proximity.

According to a further teaching, a control unit 13 for a sensor system 6 for the operation of a motorized flap arrangement 1 of a motor vehicle 2 is proposed, wherein the control unit 13 is designed to obtain, from a plurality of radar modules 7 of the sensor system 6, respective detection quality measures for a possible operator gesture detected by means of the radar modules 7 on the basis of radar sensor values, wherein the control unit 13 qualifies the possible operator gesture as a valid operator gesture or rejects it as an invalid operator gesture according to a predetermined evaluation specification on the basis of a summary of the detection quality measures, and wherein the control unit 13 initiates activation of the motorized flap arrangement 1 when a valid operator gesture is present. Reference may be made to all the embodiments of the proposed method.

According to a further teaching, a sensor arrangement for a motorized flap arrangement 1 of a motor vehicle 2 is proposed, the sensor system 6 comprising a plurality of radar modules 7, which are spaced apart from one another on the motor vehicle 2 and have respective sensor controls 8, wherein the radar modules 7, by sending and receiving radar signals, determine respective radar sensor values with respect to an operator 10 located outside the motor vehicle 2, wherein the sensor controls 8 check the radar sensor values determined by the respective radar module 7 for the presence of a possible operator gesture on the basis of predetermined operator gesture criteria, and wherein, within the scope of the check, the sensor controls 8 assign a detection quality measure to the possible operator gesture on the basis of the radar sensor values determined by the respective radar module 7, the sensor system 6 comprising a proposed control unit 13. Reference may be made to all the embodiments of the proposed method and the proposed control unit 13.

According to a further teaching, a motor vehicle 2 for carrying out the proposed method is proposed. Reference may also be made to all the embodiments of the proposed method, control unit 13 and the proposed sensor system 6.

1. A method for operating a motorized flap arrangement of a motor vehicle, using a sensor system having a plurality of radar modules, which are spaced apart from one another on the motor vehicle and have respective sensor controls,
wherein the radar modules, by sending and receiving radar signals, are used to determine respective radar sensor values with respect to an operator located outside the motor vehicle,
wherein the sensor controls are used to check the radar sensor values determined by the respective radar module for the presence of a possible operator gesture on the basis of predetermined operator gesture criteria,
wherein, within the scope of the check, the sensor controls are used to assign a detection quality measure to the possible operator gesture on the basis of the radar sensor values determined by the respective radar module,
wherein the respective detection quality measures determined by the sensor controls are transmitted to a control unit of the sensor system,
wherein the control unit is used to qualify the possible operator gesture as a valid operator gesture or to reject it as an invalid operator gesture, in accordance with a predetermined evaluation specification on the basis of a summary of the detection quality measures, and
wherein the control unit is used to initiate activation of the motorized flap arrangement when a valid operator gesture is present.

2. The method according to claim 1, wherein the sensor controls are used to derive at least one operator gesture parameter from the radar sensor values, determined by the respective radar module, of the possible operator gesture and to assign the operator gesture parameter to the possible operator gesture, in that the detection quality measures are transmitted together with the assigned operator gesture parameters to the control unit, and in that the evaluation specification is dependent on the assigned operator gesture parameters.

3. The method according to claim 2, wherein at least one operator gesture parameter relates to a temporal aspect of the possible operator gesture.

4. The method according to claim 2, wherein at least one operator gesture parameter relates to a speed value, average speed and/or an acceleration value, of the possible operator gesture.

5. The method according to claim 2, wherein at least one operator gesture parameter relates to a geometric aspect of the possible operator gesture.

6. The method according to claim 1, wherein at least one of the radar modules is used for UWB communication with a mobile device of the operator, in that the sensor control of the at least one radar module is used to determine time information and/or position information with respect to the mobile device and to transmit same to the control unit, and in that the evaluation specification is dependent on the time information and/or position information.

7. The method according to claim 1, wherein the sensor controls are used to check the radar sensor values, which are determined by the respective radar module, on the basis of predetermined operator proximity criteria for the presence of a possible operator proximity to the flap arrangement and the presence of the possible operator proximity is transmitted to the control unit, and wherein the evaluation specification is dependent on the presence of the possible operator proximity.

8. The method according to claim 1, wherein the evaluation specification is based on a trained machine learning model.

9. The method according to claim 1, wherein the evaluation specification is based on fuzzy logic.

10. The method according to claim 1, wherein the sensor controls communicate with the control unit via a LIN bus or a CAN bus of the motor vehicle.

11. A control unit for a sensor system for operating a motorized flap arrangement of a motor vehicle, wherein the control unit is designed to obtain, from a plurality of radar modules of the sensor system, respective detection quality measures for a possible operator gesture detected by the radar modules on the basis of radar sensor values,
wherein the control unit qualifies the possible operator gesture as a valid operator gesture or rejects it as an invalid operator gesture according to a predetermined evaluation specification on the basis of a summary of the detection quality measures, and wherein the control unit initiates activation of the motorized flap arrangement when a valid operator gesture is present.

12. A sensor arrangement for a motorized flap arrangement of a motor vehicle, the sensor system comprising a plurality of radar modules, which are spaced apart from one another on the motor vehicle and have respective sensor controls, wherein the radar modules, by sending and receiving radar signals, determine respective radar sensor values with respect to an operator located outside the motor vehicle, wherein the sensor controls check the radar sensor values determined by the respective radar module for the presence of a possible operator gesture on the basis of predetermined operator gesture criteria, and wherein, within the scope of the check, the sensor controls assign a detection quality measure to the possible operator gesture on the basis of the radar sensor values determined by the respective radar module, the sensor system comprising a control unit according to claim 11.

13. A motor vehicle for carrying out the method according to claim 1.

14. The method according to claim 3, wherein the temporal aspect of the possible operator gesture is a duration, a start time and/or an end time of the possible operator gesture.

15. The method according to claim 5, wherein the respective sensor control is used on the basis of the radar sensor values to associate radar targets with the possible operator gesture, and wherein at least one operator gesture parameter relates to the position, the number, the spatial distribution and/or a radar signal strength of the radar targets.

16. The method according to claim 6, wherein, with establishment of the UWB communication, at least a further of the radar modules is activa
